(19) United States
(12) Patent Application Publication
(10) Pub. No.: US 2025/0258718 A1
(43) Pub. Date: Aug. 14, 2025

(54) DISTRIBUTED COMPUTING SYSTEM PERFORMING PARTITIONED MULTIPARTY COMPUTATION

(71) Applicant: GM Global Technology Operations LLC, Detroit, MI (US)

(72) Inventors: Mohamed A. Layouni, Fraser, MI (US); Richard Gordon, Canton, MI (US); Donald K. Grimm, Utica, MI (US)

(21) Appl. No.: 18/437,754

(22) Filed: Feb. 9, 2024

(51) Int. Cl. G06F 9/50

(52) U.S. Cl. CPC G06F 9/5072; G06F 9/5077

(57) ABSTRACT

A distributed computing system that partitions a common function into an individual portion and a joint portion includes two or more networked computers, where each networked computer corresponds to a participant of the distributed computing system. The distributed computing system also includes two or more client computers that each send data to and receive data from the two or more networked computers, where each client computer corresponds to one of the participants of the distributed computing system and each of the participants of the distributed computing system agree upon a designated participant. The individual portion is computed individually by each of the client computers corresponding to one of the participants and the joint portion is computed collaboratively by each of the two or more networked computers of the distributed computing system based on multiparty computation.

### INTRODUCTION

The present disclosure relates to a distributed computing system that partitions a common function into an individual portion and a joint portion, where individual portion of the common function is computed individually by each participant of the distributed computing system and the joint portion of the common function is computed collaboratively by two or more networked computers of the distributed computing system based on multiparty computation.

Big data refers to the volume, velocity, and variety of data that various machine learning and artificial intelligence technologies rely upon to determine relationships that exist within a massive collection of data. As a result, many organizations such as vehicle and mobile telephone manufacturers are experiencing a growing reliance on big data in an effort to offer innovative services and features. However, sometimes an organization may not be able to collect the amount of information needed to build a large dataset. For example, there may not be enough vehicles produced by a particular vehicle manufacturer located within a specific geographical region to create the large dataset required to determine a particular relationship required for a specific machine learning algorithm or a specific statistical model. Accordingly, competing vehicle manufacturers are incentivized to pool their telemetry data together and compute analytics based on the union of their datasets. However, it is to be appreciated that sharing telemetry data with a competitor may not be possible because of competitive and regulatory reasons.

One solution to address the challenges described above is to employ multiparty computation between competitive organizations. Multiparty computation allows a group of mutually distrustful parties, such as competitive organizations, to compute a joint portion of their inputs without revealing information about the inputs to each other, beyond what may be inferred from the result of the computation based on the inputs. As another example, multiparty computation may also be used to comply with requests from law enforcement officials. Specifically, multiparty computing may be used to compute the intersection of a vehicle manufacturer's data with law enforcement data for the purpose of gathering information about vehicles suspected of being involved in criminal activity. This is done while preserving the privacy of vehicles not part of the law enforcement dataset. However, it is to be appreciated that multiparty computations require significant computational resources that may not be available, especially for computations on large, enterprise-scale, input data.

Thus, while current multiparty computation techniques achieve their intended purpose, there is a need in the art for an improved multiparty computation technique that requires fewer computing resources when compared to current techniques.

### SUMMARY

According to several aspects, a distributed computing system that partitions a common function into an individual portion and a joint portion is disclosed. The distributed computing system includes two or more networked computers, wherein each networked computer corresponds to a participant of the distributed computing system and two or more client computers that each send data to and receive data from the two or more networked computers. Each client computer corresponds to one of the participants of the distributed computing system and each of the participants of the distributed computing system agree upon a designated participant. The client computer corresponding to the designated participant executes instructions to classify each operation that is part of the common function as either a linear operation or a non-linear operation. In response to determining the common function includes at least one non-linear function, the client computer evaluates each non-linear operation of the common function for separability from the common function. In response to determining at least one non-linear operation is separable from the common function, the client computer partitions the common function into the individual portion and the joint portion. The individual portion is computed individually by each of the client computers corresponding to one of the participants and the joint portion is computed collaboratively by each of the two or more networked computers of the distributed computing system based on multiparty computation.

In another aspect, the individual portion includes each separable linear operation and non-linear operation of the common function, and the joint portion includes all non-separable linear operations that are part of the common function and any non-separable non-linear operations of the common function.

In yet another aspect, the client computer corresponding to the designated participant executes instructions to in response to determining all of the non-linear functions that are part of the common function are non-separable from the linear operations and that the common function includes no separable operations, determining the entire common function is the joint portion.

In an aspect, the client computer corresponding to the designated participant executes instructions to in response to determining the common function only includes linear operations, evaluating the common function for one or more separable linear operations.

In another aspect, the client computer corresponding to the designated participant executes instructions to in response to determining the common function includes the one or more separable linear operations, assign the one or more separable linear operations as the individual portion of the common function, while the remaining operations that are part of the common function are assigned as the joint portion.

In yet another aspect, the client computer corresponding to the designated participant executes instructions to in response to determining the common function includes a weighted sum of secret-shared inputs, evaluate each weight corresponding to the weighted sum of the secret-shared input, where each client computer of the distributed computing system transmits a secret-shared input to each networked computer of the distributed computing system.

In an aspect, the client computer corresponding to the designated participant executes instructions to in response to determining the value of each of the weights corresponding to the weighted sum are equal to one another, partition the common function into the individual portion that includes a multiplication operation by a common weight and the joint portion including a sum of the products of the secret-shared inputs.

In another aspect, the client computer corresponding to the designated participant executes instructions to in response to determining partitioning the common function is complete, transmit the individual portion and the joint portion of the common function to each of the client computers corresponding to the remaining participants of the distributed computing system for verification.

In yet another aspect, the client computer corresponding to the designated participant executes instructions to receive a unique notification from each of the client computers corresponding to the remaining participants of the distributed computing system, where the unique notification indicates a corresponding participant of the distributed computing system agrees the partitioning of common function is valid.

In an aspect, the client computer corresponding to the designated participant executes instructions to in response to receiving the unique notification from each of the client computers corresponding to the remaining participants of the distributed computing system, instructing each of the client computers corresponding to the remaining participants of the distributed computing system to individually compute the individual portion of the common function, and instruct the two or more networked computers that are part of the distributed computing system to jointly compute the joint portion based on multiparty computing.

In another aspect, each participant of the distributed computing system represents one of the following: a vehicle manufacturer and a mobile telephone manufacturer.

In yet another aspect, a method for partitioning a common function by a distributed computing system into an individual portion and a joint portion is disclosed. The method includes classifying, by a client computer corresponding to a designated participant of the distributed computing system, each operation that is part of the common function as either a linear operation or a non-linear operation, where the distributed computing system includes two or more participants that each include a corresponding client computer that sends data to and receives data from two or more networked computers. In response to determining the common function includes at least one non-linear function, the method includes evaluating, by the client computer corresponding to the designated participant of the distributed computing system, each non-linear operation of the common function for separability from the common function. In response to determining at least one non-linear operation is separable from the common function, the method includes partitioning, by the client computer of the designated participant, the common function into the individual portion and the joint portion, wherein the individual portion is computed individually by each of the client computers corresponding to one of the participants and the joint portion is computed collaboratively by each of the two or more networked computers of the distributed computing system based on multiparty computation.

In another aspect, the method further comprises in response to determining all of the non-linear functions that are part of the common function are non-separable from the linear operations and that the common function includes no separable operations, determining, by the client computer corresponding to the corresponding to the designated participant of the distributed computing system, the entire common function is the joint portion.

In yet another aspect, the method further comprises in response to determining the common function only includes linear operations, evaluating, by the client computer corresponding to the designated participant of the distributed computing system, the common function for one or more separable linear operations.

In an aspect, the method further comprises in response to determining the common function includes the one or more separable linear operations is a constant, assigning, by the client computer corresponding to the designated participant of the distributed computing system, the one or more separable linear operations as the individual portion of the common function, while the remaining operations that are part of the common function are assigned as the joint portion.

In yet another aspect, the method further comprises in response to determining the common function includes a weighted sum of secret-shared inputs, evaluating, by the client computer corresponding to the designated participant of the distributed computing system, a value of each weight corresponding to the weighted sum of the secret-shared input, where each client computer of the distributed computing system transmits a secret-shared input to each networked computer of the distributed computing system.

In an aspect, the method further comprises in response to determining the value of each of the weights corresponding to the weighted sum are equal to one another, partitioning, by the client computer corresponding to the designated participant of the distributed computing system, the common function into the individual portion that includes a multiplication operation by a common weight and the joint portion including a sum of the products of the secret-shared inputs.

In another aspect, the method further comprises in response to determining partitioning the common function is complete, transmitting, by the client computer corresponding to the designated participant of the distributed computing system, the individual portion and the joint portion of the common function to each of the client computers corresponding to the remaining participants of the distributed computing system for verification.

In yet another aspect, the method further comprises receiving, by the client computer corresponding to the designated participant of the distributed computing system, a unique notification from each of the client computers corresponding to the remaining participants of the distributed computing system, wherein the unique notification indicates a corresponding participant of the distributed computing system agrees the partitioning of common function is valid.

In an aspect, the method further comprises in response to receiving the unique notification from each of the client computers corresponding to the remaining participants of the distributed computing system, instructing, by the client computer corresponding to the designated participant of the distributed computing system, each of the client computers corresponding to the remaining participants of the distributed computing system to individually compute the individual portion of the common function, and instructing, by the client computer corresponding to the designated participant of the distributed computing system, the two or more networked computers that are part of the distributed computing system to jointly compute the joint portion based on multiparty computing.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed distributed computing system having two or more participants that each include a client computer in communication with a corresponding networked computer, according to an exemplary embodiment; and

FIG. 2 is a process flow diagram illustrating a method for partitioning a common function by the distributed computing system into an individual portion and a joint portion, according to an exemplary embodiment.

### DETAILED DESCRIPTION

The following description is merely exemplary in nature and is not intended to limit the present disclosure, application, or uses.

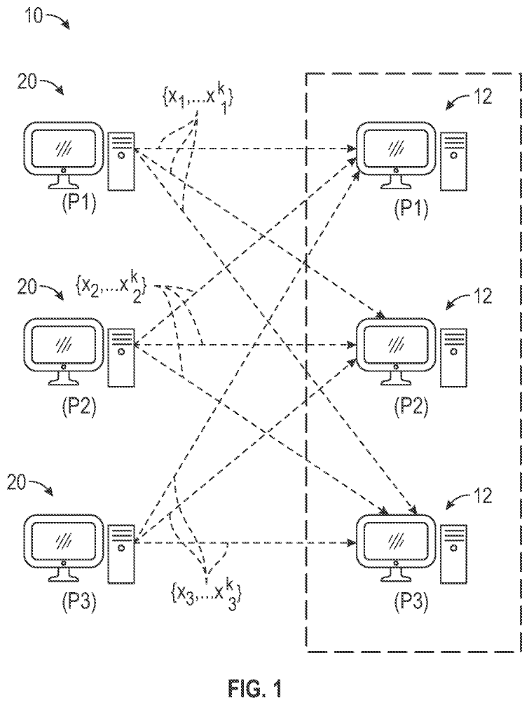

Referring to FIG. 1, the disclosed distributed computing system 10 including two or more networked computers 12 is illustrated. In the non-limiting embodiment as shown in the figures, the distributed computing system 10 includes three networked computers 12 in communication with one another, however, it is to be appreciated that FIG. 1 is merely exemplary in nature and any number of networked computers 12 may be included as well. Each networked computer 12 corresponds to a participant of the distributed computing system 10. The participant represents an entity that contributes data to the distributed computing system 10. In one embodiment, each unique participant represents a manufacturer such as, for example, a vehicle or a mobile telephone manufacturer. However, it is to be appreciated that the participants may represent other entities as well such as, but not limited to, the Internet of things (IoT) manufacturers, consumer goods manufacturers, or any other organization that possess a private database of sensitive data. In the embodiment as shown in FIG. 1, the unique participants are indicated as P1, P2, and P3. As explained below, the distributed computing system 10 partitions a common function into an individual portion and a joint portion. The individual portion of the common function is computed individually by a client computer 20 corresponding to one of the participants of the distributed computing system 10, while the joint portion of the common function is computed collaboratively by each of the two or more networked computers 12 of the distributed computing system 10 based on multiparty computation.

Each unique participant of the distributed computing system 10 includes a corresponding client computer 20. Each networked computer 12 of the distributed computing system 10 represents a server computer that corresponds to one of the participants of the distributed computing system 10, where each networked computer 12 transmits data to and receives data from each client computer 20. Each client computer 20 corresponding to one of the participants of the distributed computing system 10 transmits an input {xⱼ¹, . . . xⱼ^{k}}, which is in the form of secret shares, to each networked computer 12 of the distributed computing system 10, where j represents the identity or index of the participant the client computer 20 corresponds to, xⱼ represents the secret-shared input of participant j, and k represents the highest power of the input of participant j in a polynomial of the joint portion that each of the participants have mutually agreed upon to compute. The two or more networked computers 12 receive the secret-shared input {xⱼ, . . . xⱼ^{k}} from each client computer 20 of the distributed computing system 10, where each participant has agreed to share their respective secret-shared input {xⱼ, . . . xⱼ^{k}} with the distributed computing system 10 to compute the joint portion.

It is to be appreciated that each participant of the distributed computing system 10 agrees upon a common function that is computed by the distributed computing system 10. The common function is partitioned into an individual portion and a joint portion. The individual portion of the function computed individually by each of the client computers 20 corresponding to each participant of the distributed computing system 10, while the joint portion is jointly computed in a collaborative manner by each of the two or more networked computers 12 of the distributed computing system 10 based on multiparty computation. It is to be appreciated that each of the participants of the distributed computing system 10 agree upon and follow the partition of the common function. It is also to be appreciated that the client computers 20 corresponding to each of the participants of the distributed computing system 10 may individually compute the individual portion of the common function either before or after the networked computers 12 of the distributed computing system 10 jointly compute the joint portion.

The common function is expressed as either a Boolean function or an arithmetic function. A Boolean function includes, for example, a sequence of one or more exclusive or operations (XOR) and one or more AND operations (AND), while an arithmetic function includes a sequence of addition operations (ADD) and multiplication operations (MULT), and in some instances, non-linear operations. When the common function may be expressed as a polynomial, the common function includes only ADD and MULT operations, and the arithmetic function is said to be linear. When the common function is unable to be expressed as a polynomial, the common function is said to be non-linear.

It is to be appreciated that all of the participants of the distributed computing system 10 agree upon a designated participant, where the client computer 20 corresponding to the designated participant determines the common function and partitions the common function into the individual portion and the joint portion. It is also to be appreciated that once the client computer 20 corresponding to the designated participant partitions the common function into the individual portion and the joint portion, the client computer 20 corresponding to the designated participant transmits the individual portion and the joint portion of the common function to the client computers 20 corresponding to the remaining participants of the distributed computing system 10. The remaining participants verify that the partitioning is correct and consistent with the common function. Requiring each participant to verify the partitioning is correct and consistent with the common function ensures that the participants of the distributed computing system 10 are in lockstep with one another and performing computations that other participants expect.

The client computer 20 corresponding to the designated participant of the distributed computing system 10 classifies each operation that is part of the common function as a linear operation or a non-linear operation. The client computer 20 corresponding to the designated participant of the distributed computing system 10 then evaluates each non-linear operation that is part of the common function for separability. It is to be appreciated that an operation is separable if the operation involves input variables from a single participant. Hence, the operation may be computed separately from the remaining function by the single participant who holds the input variables corresponding to the operation. In response to determining the common function includes at least one non-linear operation that is separable from the common function, the client computer 20 of the designated participant partitions the common function into the individual portion and the joint portion. The individual portion of the common function includes each of the separable non-linear operations and each of the separable linear operations. As mentioned above, the individual portion of the common function is computed individually by each client computer 20 corresponding to one of the participants of the distributed computing system 10. The joint portion is jointly computed by each of the two or more networked computers 12 that are part of the distributed computing system 10. It is to be appreciated that the joint portion includes all of the non-separable linear operations that are part of the common function as well as any non-separable non-linear operations of the common function. It is to be appreciated that including separable non-linear operations as part of the individual portion of the common function results in significant computational savings when computing the common function compared to computing the identical common function while leaving all non-linear operations as part of the joint portion of the common function.

In response to determining all of the non-linear functions that are part of the common function are non-separable from the linear operations that are part of the common function and that the common function includes no separable operations, the client computer 20 corresponding to the designated participant of the distributed computing system 10 determines the entire common function is the joint portion. As mentioned above, the joint portion is jointly computed by each of the two or more networked computers 12 that are part of the distributed computing system 10 based on multiparty computation.

In response to determining the common function only includes linear operations and does not include non-linear operations, the client computer 20 corresponding to the designated participant of the distributed computing system 10 then evaluates the common function to identify one or more separable linear operations. In response to determining the common function includes one or more separable linear operations, the client computer 20 corresponding to the designated participant of the distributed computing system 10 assigns the one or more separable linear operations as the individual portion of the common function, while the remaining operations that are part of the common function are assigned as the joint portion of the common function.

In response to determining the common function includes a weighted sum of the secret-shared inputs {xⱼ, . . . xⱼ^{k}}, the client computer 20 corresponding to the designated participant of the distributed computing system 10 then evaluates a value of each of the weights corresponding to the weighted sum of the secret-shared inputs {xⱼ, . . . xⱼ^{k}}. In response to determining the value of each of the weights are equal to one another, the client computer 20 corresponding to the designated participant of the distributed computing system 10 determines the weighted sum of the secret-shared inputs {xⱼ, . . . xⱼ^{k}} is capable of being expressed as a common weight that is multiplied by a sum portion of the weighted sum. The client computer 20 corresponding to the designated participant of the distributed computing system 10 partitions the common function into the individual portion and the joint portion. The individual portion includes a multiplication operation by the common weight, and the joint portion includes the sum of the products of the secret-shared inputs {xⱼ, . . . xⱼ^{k}}.

Once the client computer 20 corresponding to the designated participant partitions the common function into the individual portion and the joint portion, the client computer 20 corresponding to the designated participant transmits the individual portion and the joint portion of the common function to each of the client computers 20 corresponding to the remaining participants of the distributed computing system 10 for verification. The client computers 20 corresponding to the remaining participants of the distributed computing system 10 each verify that the partitioning is correct and consistent with the common function and transmit a unique notification to the client computer 20 corresponding to the designated participant indicating the partitioning is valid. Once the client computer 20 corresponding to the designated participant receives the unique notification from each of the client computers 20 corresponding to the remaining participants of the distributed computing system 10, the client computer 20 corresponding to the designated participant instructs each of the client computers 20 corresponding to the remaining participants of the distributed computing system 10 to individually compute the individual portion of the common function. The client computer 20 corresponding to the designated participant also instructs the two or more networked computers 12 that are part of the distributed computing system 10 to jointly compute the joint portion based on multiparty computation.

As an example, Equation 1 is a linear multi-variate polynomial that represents the common function, and is as follows:

$$f ( {x}_{1} , … {x}_{j} , … , {x}_{n} ) = {\sum }_{{i}_{1} = 0}^{{k}_{1}} … {\sum }_{{i}_{j}}^{{k}_{j}} … {\sum }_{{i}_{n} = 0}^{{k}_{n}} {a}_{{i}_{1}}^{( 1 )} … {a}_{{i}_{j}}^{( j )} … {a}_{{i}_{n}}^{( n )} \cdot {x}_{1}^{{i}_{1}} … {x}_{j}^{{i}_{j}} … {x}_{n}^{{i}_{n}} \qquad Equation 1$$

where xⱼ denotes the secret-shared input of participant j, aᵢ_{ⱼ}^{(j)} represents a coefficient of the multi-variate polynomial, j represents an index of the participant the client computer 20 corresponds to, and n represents the total number of participants that are part of the distributed computing system 10. Assuming that the coefficient aᵢ_{ⱼ}^{(j)} is constant for each participant j of the distributed computing system 10, Equation 1 is partitioned into an individual portion, which includes the multiplication operation (a)ᵢ_{₁}⁽¹⁾ . . . aᵢ_{ₙ}⁽ⁿ⁾·f′ (x₁, . . . , xₙ)) that is computed locally by the client computer 20 corresponding to each participant, and a joint portion f′ (x₁, . . . , xₙ), which includes the addition operation (Σᵢ_{₁}₌₀^{k}^{₁} . . . Σᵢ_{ₙ}₌₀^{k}^{ₙ}x₁ⁱ^{₁} . . . xₙⁱ^{ₙ}) that is jointly computed by the two or more networked computers 12.

As another example, Equation 2, which includes a non-linear function, is expressed below as:

$$f ( {x}_{1} , … , {x}_{n} ) = g ( {\sum }_{{i}_{1} = 0}^{{k}_{1}} … {\sum }_{{i}_{n} = 0}^{{k}_{n}} {a}_{{i}_{1}}^{( 1 )} … {a}_{{i}_{n}}^{( n )} \cdot {x}_{1}^{{i}_{1}} … {x}_{n}^{{i}_{n}} ) \qquad Equation 2$$

where g represents a non-linear function that may not be expressed or approximated by a multi-variate polynomial. Similar to Equation 1, assuming that the non-linear function g is separable from the linear operations of the common function, Equation 2 is partitioned into an individual portion, which includes the nonlinear function g as well as any separable operations that are computed locally by the client computer 20 corresponding to each participant, and a joint portion, which includes the non-separable operations that are jointly computed by the two or more networked computers 12.

In yet another example, Equation 3 is a joint portion that determines an average of the secret-shared input {x₁, . . . xⱼ^{k}} as:

$$Avg ( {x}_{1} , … , {x}_{n} ) = \frac{1}{n} \cdot {\sum }_{i = 0}^{n} {x}_{i} \qquad Equation 3$$

Equation 3 is partitioned into an individual portion, which includes the multiplication operation (dividing the sum of the addition function by 1/n) computed locally by the client computer 20 corresponding to each participant, and a joint portion, which includes the addition operations (i.e., x₁+x₂, . . . , xₙ₋₁+xₙ) that is jointly computed by the two or more networked computers 12.

In an example, Equation 4 is a joint portion that includes a common term m, where the value of the common term m varies between each of the participants of the distributed computing system 10. Equation 4 is expressed as:

$$f ( {x}_{1} , … , {x}_{n} ) = {( {\sum }_{i = 0}^{n} {x}_{i} )}^{m} = {\sum }_{{k}_{1} + … + {k}_{n} = m} ( \begin{matrix}m \\ {k}_{1} , … , {k}_{n}\end{matrix} ) \cdot {x}_{1}^{{k}_{1}} … {x}_{n}^{{k}_{n}} \qquad Equation 4$$

wherein

$$( \begin{matrix}m \\ {k}_{1} , … , {k}_{n}\end{matrix} ) = \frac{m !}{{k}_{1} ! … {k}_{n} !} .$$

It is to be appreciated that Equation 4 is not partitioned into an individual portion, since the weights

$$( \begin{matrix}m \\ {k}_{1} , … , {k}_{n}\end{matrix} ) = \frac{m !}{{k}_{1} ! … {k}_{n} !}$$

are not equal across each of the participants of the distributed computing system 10. Instead, Equation 4 is only expressed as a joint portion that is jointly computed by the two or more networked computers 12.

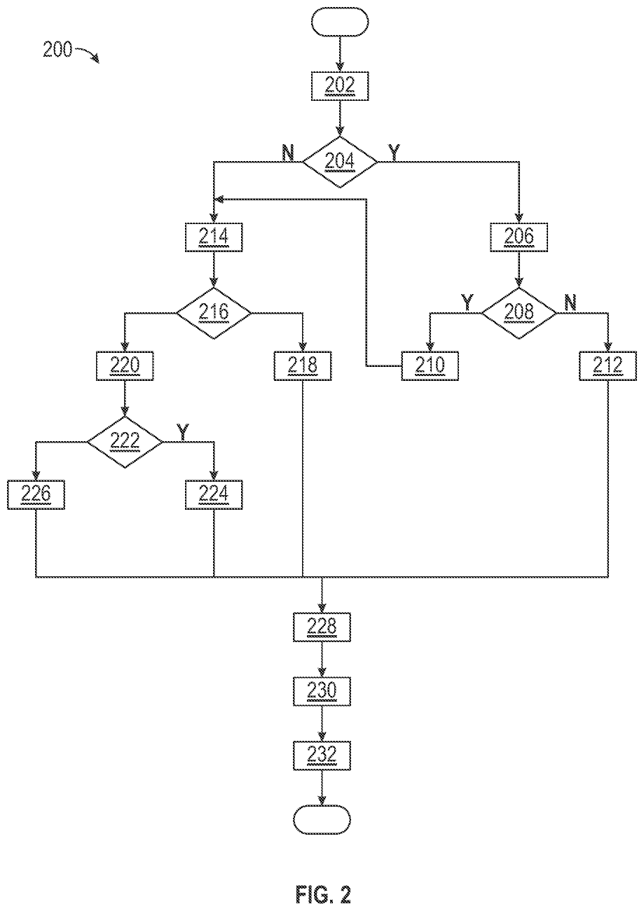

FIG. 2 is a process flow diagram illustrating a method 200 for partitioning a common function by the distributed computing system into an individual portion and a joint portion. Referring generally to FIGS. 1 and 2, the method 200 may begin at block 202. In block 202, the client computer 20 corresponding to the designated participant of the distributed computing system 10 classifies each operation that is part of the common function as either a linear operation or a non-linear operation. The method 200 may then proceed to decision block 204.

In decision block 204, if the common function includes at least one non-linear operation then then method proceeds to block 206. In block 206, in response to determining the common function includes at least one non-linear function, the client computer 20 corresponding to the designated participant of the distributed computing system 10 evaluates each non-linear operation of the common function for separability. The method 200 may then proceed to decision block 208.

In decision block 208, if the common function includes at least one non-linear operation that is separable from the common function, then the method 200 may proceed to block 210.

In block 210, in response to determining the at least one non-linear operation that is separable from the common function, the client computer 20 of the designated participant partitions the common function into the individual portion and the joint portion. The individual portion of the common function includes each of the separable non-linear operations and each of the separable linear operations, and the joint portion includes all of the non-separable linear operations that are part of the common function as well as any non-separable non-linear operations of the common function. The method 200 may then proceed to block 214.

Referring back to decision block 208, if the common function does not include at least one non-linear operation that is separable from the linear operations that is part of the common function, then the method 200 may proceed to block 212.

In block 212, in response to determining all of the non-linear functions that are part of the common function are non-separable from the linear operations that are part of the common function and that the common function includes no separable operations, the client computer 20 corresponding to the designated participant of the distributed computing system 10 determines the entire common function is the joint portion. The method 200 may then proceed to block 228.

Referring back to decision block 204, if the common function does not include at least one non-linear operation then then method proceeds to block 214. In block 214, in response to determining the common function only includes linear operations and does not include non-linear operations, the client computer 20 corresponding to the designated participant of the distributed computing system 10 evaluates the common function for one or more separable linear operations. The method 200 may then proceed to decision block 216.

In decision block 216, if the common function includes one or more separable linear operations, then the method 200 proceeds to block 218. In block 218, in response to determining the common function includes one or more separable linear operations, the client computer 20 assigns the one or more separable linear operations as the individual portion, and a remaining portion of the common function that does not include the one or more separable linear operations is the joint portion. The method 200 may then proceed to block 228.

Referring back to decision block 216, if the common function includes a weighted sum of the secret-shared inputs {xⱼ, . . . xⱼ^{k}}, then the method 200 may proceed to block 220.

In block 220, in response to determining the common common function includes the weighted sum of the secret-shared inputs {xⱼ, . . . xⱼ^{k}}, the client computer 20 corresponding to the designated participant of the distributed computing system 10 evaluates a value of each of the weights corresponding to the weighted sum of the secret-shared inputs {xⱼ, . . . xⱼ^{k}}. As mentioned above, each client computer 20 corresponding to one of the participants of the distributed computing system 10 transmits a secret-shared input {xⱼ¹, . . . xⱼ^{k}} to each networked computer 12 of the distributed computing system 10. The method 200 may then proceed to decision block 222.

In decision block 222, if the value of each of the weights corresponding to weighted sum of the secret-shared inputs {xⱼ, . . . xⱼ^{k}} are equal to one another, then the method 200 may proceed to block 224.

In block 224, in response to determining the value of each of the weights corresponding to the weighted sum are equal to one another, the client computer 20 corresponding to the designated participant of the distributed computing system 10 determines the weighted sum of the secret-shared inputs {xⱼ, . . . xⱼ^{k}} is capable of being expressed as a common weight that is multiplied by a sum portion of the weighted sum. The client computer 20 corresponding to the designated participant of the distributed computing system 10 partitions the common function into the individual portion, which includes a multiplication operation by the common weight, and the joint portion, which includes the sum of the products of the secret-shared inputs {xⱼ, . . . xⱼ^{k}}. The method 200 may then proceed to block 228.

Returning to decision block 222, if the value of each of the weights corresponding to the weighted sum of the secret-shared inputs {xⱼ, . . . xⱼ^{k}} are unequal to one another, then the method 200 may proceed to block 226.

In block 226, in response to determining the weights are unequal to one another, the client computer 20 corresponding to the designated participant of the distributed computing system 10 determines the common function is the joint portion. The method 200 may then proceed to block 228.

In block 228, in response to determining partitioning the common function is complete, the client computer 20 corresponding to the designated participant transmits the individual portion and the joint portion of the common function to each of the client computers 20 corresponding to the remaining participants of the distributed computing system 10 for verification. The method 200 may then proceed to block 230.

In block 230, the client computer 20 corresponding to the designated participant receives a unique notification from each of the client computers 20 corresponding to the remaining participants of the distributed computing system 10, where the unique notification indicates a corresponding participant of the distributed computing system 10 agrees the partitioning of common function is valid. The method 200 may then proceed to block 232.

In block 232, in response to receiving the unique notification from each of the client computers 20 corresponding to the remaining participants of the distributed computing system 10, the client computer 20 corresponding to the designated participant instructs each of the client computers 20 corresponding to the remaining participants of the distributed computing system 10 to individually compute the individual portion of the common function. The client computer 20 corresponding to the designated participant also instructs the two or more networked computers 12 that are part of the distributed computing system 10 to jointly compute the joint portion based on multiparty computing. The client computer 20 corresponding to the designated participant also indicates which order the operations of the individual portion and the joint portion of the common function to the remaining participants of the distributed computing system 10. The method 200 may then terminate.

Referring generally to the figures, the disclosed distributed computing system provides various technical effects and benefits. Specifically, the distributed computing system provides an approach for partitioning a common function into an individual portion, which is computed individually by each participant, and a joint portion that is jointly computed by each of the networked computers based on multiparty computation. Partitioning the common function into separate portions allows for the participants to compute more complex functions individually, thereby reducing the computing resources required by the networked computers to perform the multiparty computation. In particular, the disclosed approach allows for minimizing computation operations such as the and operation (AND), which is a Boolean function, and the multiplication operation (MULT), which is an arithmetic function, inside the joint portion of the common function, since the and the multiplication operations both require a significant amount of resources to compute using multiparty computations. It is also to be appreciated that solving the joint portion based on multiparty computation ensures that a participant does not discover the secret-shared input of another participant of the distributed computing system.

The computers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the computers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A distributed computing system that partitions a common function into an individual portion and a joint portion, the distributed computing system comprising:
two or more networked computers, wherein each networked computer corresponds to a participant of the distributed computing system;
two or more client computers that each send data to and receive data from the two or more networked computers, wherein each client computer corresponds to one of the participants of the distributed computing system and each of the participants of the distributed computing system agree upon a designated participant, and wherein the client computer corresponding to the designated participant executes instructions to:
classify each operation that is part of the common function as either a linear operation or a non-linear operation;
in response to determining the common function includes at least one non-linear function, evaluate each non-linear operation of the common function for separability from the common function; and
in response to determining at least one non-linear operation is separable from the common function, partition the common function into the individual portion and the joint portion, wherein the individual portion is computed individually by each of the client computers corresponding to one of the participants and the joint portion is computed collaboratively by each of the two or more networked computers of the distributed computing system based on multiparty computation.

2. The distributed computing system of claim 1, wherein the individual portion includes each separable linear operation and non-linear operation of the common function, and the joint portion includes all non-separable linear operations that are part of the common function and any non-separable non-linear operations of the common function.

3. The distributed computing system of claim 1, wherein the client computer corresponding to the designated participant executes instructions to:
in response to determining all of the non-linear functions that are part of the common function are non-separable from the linear operations and that the common function includes no separable operations, determining the corresponding to the designated participant of the distributed computing system, the entire common function is the joint portion.

4. The distributed computing system of claim 3, wherein the client computer corresponding to the designated participant executes instructions to:
in response to determining the common function only includes linear operations, evaluating the common function for one or more separable linear operations.

5. The distributed computing system of claim 4, wherein the client computer corresponding to the designated participant executes instructions to:
in response to determining the common function includes the one or more separable linear operations, assign the one or more separable linear operations as the individual portion of the common function, while the remaining operations that are part of the common function are assigned as the joint portion.

6. The distributed computing system of claim 4, wherein the client computer corresponding to the designated participant executes instructions to:
in response to determining the common function includes a weighted sum of secret-shared inputs, evaluate each weight corresponding to the weighted sum of the secret-shared input, wherein each client computer of the distributed computing system transmits a secret-shared input to each networked computer of the distributed computing system.

7. The distributed computing system of claim 6, wherein the client computer corresponding to the designated participant executes instructions to:
in response to determining the value of each of the weights corresponding to the weighted sum are equal to one another, partition the common function into the individual portion that includes a multiplication operation by a common weight and the joint portion including a sum of the products of the secret-shared inputs.

8. The distributed computing system of claim 1, wherein the client computer corresponding to the designated participant executes instructions to:
in response to determining partitioning the common function is complete, transmit the individual portion and the joint portion of the common function to each of the client computers corresponding to the remaining participants of the distributed computing system for verification.

9. The distributed computing system of claim 8, wherein the client computer corresponding to the designated participant executes instructions to:
receive a unique notification from each of the client computers corresponding to the remaining participants of the distributed computing system, wherein the unique notification indicates a corresponding participant of the distributed computing system agrees the partitioning of common function is valid.

10. The distributed computing system of claim 9, wherein the client computer corresponding to the designated participant executes instructions to:
in response to receiving the unique notification from each of the client computers corresponding to the remaining participants of the distributed computing system, instructing each of the client computers corresponding to the remaining participants of the distributed computing system to individually compute the individual portion of the common function; and
instruct the two or more networked computers that are part of the distributed computing system to jointly compute the joint portion based on multiparty computing.

11. The distributed computing system of claim 1, wherein each participant of the distributed computing system represents one of the following: a vehicle manufacturer and a mobile telephone manufacturer.

12. A method for partitioning a common function by a distributed computing system into an individual portion and a joint portion, the method comprising:
classifying, by a client computer corresponding to a designated participant of the distributed computing system, each operation that is part of the common function as either a linear operation or a non-linear operation, wherein the distributed computing system includes two or more participants that each include a corresponding client computer that sends data to and receives data from two or more networked computers;
in response to determining the common function includes at least one non-linear function, evaluating, by the client computer corresponding to the designated participant of the distributed computing system, each non-linear operation of the common function for separability from the common function; and
in response to determining at least one non-linear operation is separable from the common function, partitioning, by the client computer of the designated participant, the common function into the individual portion and the joint portion, wherein the individual portion is computed individually by each of the client computers corresponding to one of the participants and the joint portion is computed collaboratively by each of the two or more networked computers of the distributed computing system based on multiparty computation.

13. The method of claim 12, wherein the method further comprises:
in response to determining all of the non-linear functions that are part of the common function are non-separable from the linear operations and that the common function includes no separable operations, determining, by the client computer corresponding to the corresponding to the designated participant of the distributed computing system, the entire common function is the joint portion.

14. The method of claim 12, wherein the method further comprises:
in response to determining the common function only includes linear operations, evaluating, by the client computer corresponding to the designated participant of the distributed computing system, the common function for one or more separable linear operations.

15. The method of claim 14, wherein the method further comprises:
in response to determining the common function includes the one or more separable linear operations is a constant, assigning, by the client computer corresponding to the designated participant of the distributed computing system, the one or more separable linear operations as the individual portion of the common function, while the remaining operations that are part of the common function are assigned as the joint portion.

16. The method of claim 14, wherein the method further comprises:
in response to determining the common function includes a weighted sum of secret-shared inputs, evaluating, by the client computer corresponding to the designated participant of the distributed computing system, a value of each weight corresponding to the weighted sum of the secret-shared input, wherein each client computer of the distributed computing system transmits a secret-shared input to each networked computer of the distributed computing system.

17. The method of claim 16, wherein the method further comprises:
in response to determining the value of each of the weights corresponding to the weighted sum are equal to one another, partitioning, by the client computer corresponding to the designated participant of the distributed computing system, the common function into the individual portion that includes a multiplication operation by a common weight and the joint portion including a sum of the products of the secret-shared inputs.

18. The method of claim 12, wherein the method further comprises:
in response to determining partitioning the common function is complete, transmitting, by the client computer corresponding to the designated participant of the distributed computing system, the individual portion and the joint portion of the common function to each of the client computers corresponding to the remaining participants of the distributed computing system for verification.

19. The method of claim 18, wherein the method further comprises:
receiving, by the client computer corresponding to the designated participant of the distributed computing system, a unique notification from each of the client computers corresponding to the remaining participants of the distributed computing system, wherein the unique notification indicates a corresponding participant of the distributed computing system agrees the partitioning of common function is valid.

20. The method of claim 19, wherein the method further comprises:
in response to receiving the unique notification from each of the client computers corresponding to the remaining participants of the distributed computing system, instructing, by the client computer corresponding to the designated participant of the distributed computing system, each of the client computers corresponding to the remaining participants of the distributed computing system to individually compute the individual portion of the common function; and
instructing, by the client computer corresponding to the designated participant of the distributed computing system, the two or more networked computers that are part of the distributed computing system to jointly compute the joint portion based on multiparty computing.
